(19) United States
(12) Patent Application Publication
(10) Pub. No.: US 2018/0033043 A1
(43) Pub. Date: Feb. 1, 2018

(54) SYSTEMS AND METHODS FOR PROVIDING IN-STORE ADVERTIZING INCENTIVES TO CUSTOMER-MEMBERS OF A RETAILER

(71) Applicant: Wal-Mart Stores, Inc., Bentonville, AR (US)

(72) Inventors: Nicholaus A. Jones, Fayetteville, AR (US); Steven Lewis, Bentonville, AR (US); Matthew Biermann, Fayetteville, AR (US)

(21) Appl. No.: 15/662,049

(22) Filed: Jul. 27, 2017

Related U.S. Application Data
(60) Provisional application No. 62/368,323, filed on Jul. 29, 2016.

(51) Int. Cl. G06Q 30/02

(52) U.S. Cl. CPC G06Q 30/0258; G06Q 30/0261; G06Q 30/0268

(57) ABSTRACT

Embodiments relate to systems and methods for providing in-store advertizing incentives to customer-members of a business, such as a retailer, wholesaler or other business. In embodiments, the advertizing incentive can be based on customer-members visiting a retail location and/or making a purchase from the retailer. Content for the advertisement can be provided by the customer-member, and the advertisement can be displayed in the retail location. In some embodiments, the advertisement can be cooperative in that it includes information about both the customer-member and the retailer. For example, the advertisement can include information about a product purchased by the customer-member from the retailer and information about the customer-member's business. The advertisement can comprise a print-type advertisement, a commercial with video and audio information, an audio-only commercial, or some other type of advertisement.

### RELATED APPLICATION

The present application claims the benefit of U.S. Provisional Application No. 62/368,323 filed Jul. 29, 2016, which is hereby incorporated herein in its entirety by reference.

### TECHNICAL FIELD

Embodiments relate generally to incentives for customers of a retailer, and more particularly to systems and methods for providing in-store advertizing incentives to customers who are also members of a retailer.

### BACKGROUND

Businesses, including retailers, often offer incentives to their customers to build loyalty and improve customer experience. These incentives can include coupons, special sales, discounts, and other offers. Some retail and wholesale businesses operate using a membership system, in which customers must join and become members in order to enter and/or make purchases. Membership-based customers (“customer-members”), including those who are also business owners themselves, present opportunities for new and different incentives that add value to their businesses.

### SUMMARY

In an embodiment, a system for providing an advertizing incentive, by a retailer having a retail location and offering a member relationship to customers, to a customer-member of the retailer, comprises an electronic customer-member identification module configured to be arranged in the retail location to identify a presence in the retail location of a customer-member of the retailer; a display module; and an advertising module communicatively coupled with the electronic customer-member identification module and the display module and configured to receive an electronic advertisement related to the customer-member and to cause the display module to display the electronic advertisement according to at least one characteristic related to the identified presence of the customer-member in the retail location.

In an embodiment, a method of providing an advertizing incentive, by a retailer having a retail location and offering a member relationship with customers, to a customer-member of the retailer, comprises receiving an electronic advertisement from to the customer-member; identifying, by an electronic customer-member identification module configured to be arranged in the retail location, a presence in the retail location of the customer-member; and causing to be displayed on a display module, by an advertising module communicatively coupled with the electronic customer-member identification module, the electronic advertisement in the retail location according to at least one characteristic related to the identifying of the customer-member in the retail location.

### BRIEF DESCRIPTION OF THE DRAWINGS

Embodiments may be more completely understood in consideration of the following detailed description of various embodiments in connection with the accompanying drawings, in which:

FIG. 1 is a block diagram of an in-store advertizing incentive system according to an embodiment.

FIG. 2 is a block diagram of a retail location according to an embodiment.

FIG. 3 is a flowchart of a method of in-store advertizing according to an embodiment.

FIG. 4 is a block diagram of an in-store advertizing incentive system according to another embodiment.

### DETAILED DESCRIPTION

Embodiments are directed to systems and methods for providing in-store advertizing incentives to customer-members of a business, such as a retailer, wholesaler or other business. These businesses will be referred to herein as “retailers” for convenience but without limitation with respect to a particular type of business (e.g., “retailers” includes wholesale businesses). In embodiments, the advertizing incentive can be based on customer-members visiting a retailer and/or making a purchase at the retailer. Content for the advertisement can be provided by the customer-member, and the advertisement can be displayed in the retailer. In some embodiments, the advertisement can be cooperative in that it includes information about both the customer-member and the retailer. For example, the advertisement can include information about a product purchased by the customer-member at the retailer and information about the customer-member's business location. The advertisement can comprise a print-type advertisement, a commercial with video and audio information, an audio-only commercial, or some other type of advertisement.

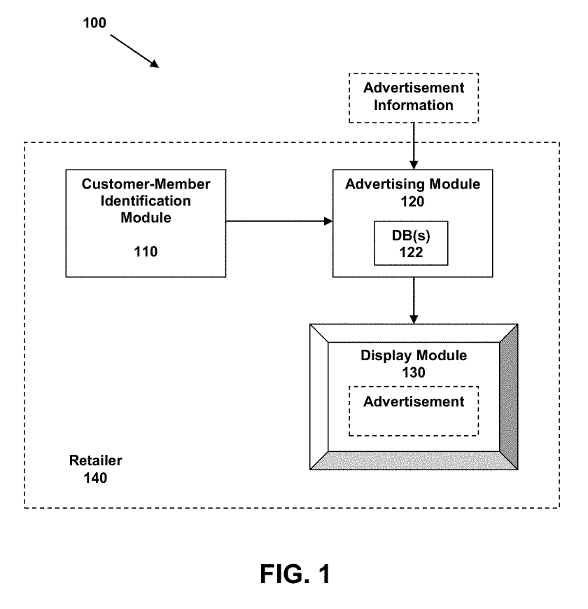

Referring to FIG. 1, an embodiment of an in-store advertizing system 100 is depicted. System 100 comprises a customer-member identification module 110, an advertizing module 120 and a display module 130 in one embodiment. Customer-member identification module 110, advertising module 120 and display module 130 are located in a retailer 140 in one embodiment. In another embodiment, advertizing module 120 may be located remote from retailer 140 but communicatively coupled with customer-member identification modules 110 and display modules 130 in one or more retailers 140.

In one embodiment, customer-member identification module 110 comprises a kiosk, stand or other physical unit that includes or supports one or more electronic elements or devices via which a customer-member can be identified. In embodiments, the customer-member is identified electronically, such as via a membership card, a credit or debit card, a chip-and-pin card, a card comprising a radio frequency identification (RFID) chip, an identification card, an electronic card displayed on a cell phone or other mobile electronic device, or some other card. In other embodiments, electronic identification of the customer-member can be done using biometric information, which could include fingerprints, voice recognition, facial recognition or other biometric information. In still other embodiments, electronic identification of the customer-member can include a customer-member log-in using a username and password or other identification. Thus, in various embodiments, customer-member identification module 110 comprises at least one of a magnetic stripe reader, a bar code reader, a contactless electronic payment terminal, a chip-and-pin reader, a biometric identification system, a scanner, a mouse, a camera, a voice recognition system, a radio frequency identification (RFID) system, a BLUETOOTH system, a WIFI system, a near-field communication (NFC) antenna, or a keyboard. Customer-member identification module 110, in any embodiment, also can comprise display capabilities configured to display prompts or other interfaces to the customer-member or another user (e.g., retailer personnel) to determine the customer-member's identity.

In embodiments, customer-member identification module 110 is arranged at or proximate to an entrance to retailer 140 to electronically identify a customer-member's presence in retailer 140 as the customer-member enters retailer 140, either automatically (e.g., via one of the wireless technologies discussed above) or manually (e.g., via customer-members swiping or scanning their membership card). In other embodiments, customer-member identification module 110 is arranged or otherwise configured to detect or determine a customer-member's presence in or at another location in retailer 140.

Still other ways of identifying customer-members can be used. For example, retailer personnel can operate handheld scanners, readers or other devices, including those which comprise one or more of the technologies identified above. In another example, electronic identification of the customer-member can be accomplished by detecting a mobile device (e.g., smartphone, tablet, wearable electronic device) within a geofence associated with retailer 140.

Customer-member identification module 110 is communicatively coupled with advertising module 120. In embodiments, this communicative coupling can be wired, wireless, or a combination thereof. For example, customer-member identification module 110 and advertising module 120 can comprise circuitry and components configured for one or more of radio frequency (RF) communications, WIFI communications, BLUETOOTH communications, or near-field communications (NFC). Other suitable communication circuitries can likewise be utilized, alone or in combination. In embodiments, both customer-member identification module 110 and advertising module 120 are configured for the same wireless protocol.

Advertising module 120 comprises an engine or other device configured to receive customer-member identification data from customer-member identification module 110. In one embodiment, advertising module 120 is configured to receive data and information from customer-member identification modules 110 at more than one retailer 140. For example, advertising module 120 can be located at a home office, regional distribution or other center, or other location to serve all retailers 140 in an organization, in a state or region, or according to some other group or sub-group. In embodiments, advertising module 120 comprises a real-world device, component, or arrangement of components implemented using hardware, such as by an application specific integrated circuit (ASIC) or field-programmable gate array (FPGA), for example, or as a combination of hardware and software, such as by a microprocessor system and a set of program instructions that cause the engine to implement the particular functionality discussed herein.

In some embodiments, advertising module 120 comprises or is communicatively coupled with one or more databases 122 configured to store customer-member identification data and/or information related thereto after receipt. Database(s) 122 also can comprise or store customer-member incentive enrollment information. Embodiments discussed herein, in which customer-members receive in-store advertising of their business in return for visiting and/or purchasing at retailer 140, can require customer-members to enroll in, register for, or apply to the incentive program before beginning to earn or receive the incentive. In some embodiments, customer-member enrollment can be automatic following customer-application registration for the program. In other embodiments, customer-member applications may require retailer approval before entering the program. In still other embodiments, customer-members may be required to earn or qualify for enrollment in the program, such as by visiting retailer 140 a required number of times or making purchases from retail 140 of some predetermined value. Database(s) 122 can include information regarding enrolled customer-members in order to compare and verify that information with data and information received from customer-member identification module 110 and other sources.

Advertising module 120 also is configured to receive external advertisement information and store this information in database(s). In one embodiment, the external advertisement information is provided electronically by a customer-member of retailer 140, such as via the internet. For example, retailer 140 can provide a fillable web-based form, and a customer-member who also owns or is affiliated with a business can provide advertisement information about their business by completing the form. In other embodiments, the advertisement information can be provided via email or in some other electronic way, on a drive or disk, by scanning or downloading files at a kiosk or computer at retailer 140, or in hard copy form.

The advertisement information can include business information (e.g., location, hours, contact information), information about products or services offered by the business, specials offered by the business, logos, photos, graphics, video, audio, etc. The advertisement information also can include suggestions for highlighting products or services offered by retailer 140 that complement the business. If the business is a restaurant, the advertisement information can include information about products purchased at retailer 140 and their use at the business. For example, if the business is a restaurant, and a customer-member purchases fresh strawberries at retailer 140 to use in making pies served at the restaurant, the advertisement information can include information about the fresh strawberries and the resulting pie. In another example, if the business is a daycare, the advertisement information can include information about diapers or other infant or childcare products purchased at retailer 140 and used by the daycare. This complementary products information is optional and need not be provided in every instance or embodiment.

Upon receiving advertisement information, in whatever form and from whatever source, advertising module 120 can store the advertisement information in database(s) 122. In some embodiments, review or approval of the advertisement information received from the customer-member may be required before being stored in database(s) 122 or before additional next steps are taken. The review or approval can be electronic (e.g., by advertising module 120) or it may be done by personnel of or affiliated with retailer 140.

Advertising module 120 then can use the received information and/or other information stored in database(s) 122 to prepare an advertisement for display in retailer 140. In some embodiments, advertisement preparation can be automatic, such as by storing one or more advertisement templates in advertising module 120 and updating a template based on the received advertisement information. For example, a template advertisement can require the customer-member business's name, logo, street address and website, and advertising module 120 can automatically complete the template for a particular business based the received advertisement information, which itself can be provided by the customer-member completing a template or fillable form. In other embodiments, the customer-member portion of the advertisement can be partially or completely prepared manually or outside of advertising module 120, such as by personnel at or associated with retailer 140 or by the related customer-member. For example, advertising module 120 can provide a draft advertisement for approval or editing by personnel at retailer 140 and/or the customer-member. In still other embodiments, a customer-member may choose to have a custom advertisement created by its own advertising agent, or a customer-member may have a preferred or standard advertisement used by their business that is provided wholesale to advertising module 120.

In embodiments, preparing the advertisement also includes adding information from or about retailer 140. Returning to the example in which the business is a restaurant, and a customer-member purchases fresh strawberries at retailer 140 to use in making pies served at the restaurant, the customer-member advertisement information can include information about the fresh strawberries and the resulting pie while the information about retailer 140 can include the aisle in which fresh strawberries can be found and their current price. In other example, information from or about retailer 140 can include a product name, a product brand, a product price, a product location in the business location, or a product offer.

In embodiments, advertising module 120 is configured to add or determine this information automatically. In one embodiment, advertising module 120 can be programmed with or otherwise obtain information about current in-store specials or demonstration/samples, match this information with a suitable advertisement or advertisement information from a customer-member, and create, update or otherwise prepare an advertisement based thereupon. For example, retailer 140 may be hosting a product sample station for a chocolate ice cream topping on a particular day, and a customer-member who purchases that chocolate ice cream topping and offers it on sundaes in its ice cream shop visits retailer 140 on that day. Advertising module 140 can determine this and create an advertisement featuring the customer-member's ice cream shop while also providing the location of the in-store sample station. In other embodiments, this information can be provided instead by the customer-member or added by personnel of or affiliated with retailer 140.

Once the advertisement is prepared, the advertisement can be stored in database(s) 122. Any particular customer-member can have more than one advertisement stored, as customer-members may be associated with multiple businesses, have seasonal business or variations in products and services offered, or have a variety of different products or services to advertise. Additionally, retailer 140 may encourage or solicit advertisements or content from particular customer-members to complement special offers, highlight seasonal items, or for other purposes. In the restaurant business example, the advertisement about the business's use of strawberries purchased at retailer 140 may run during a time of year when strawberries are in season or when retailer 140 is running a special or coupon offer for strawberries. The same business may be associated with an advertisement for apples in the fall apple season. In embodiments, advertising module 120 can store rules or other information related to when particular advertisements or content should or may be run, and these rules can be determined by the customer-member, retailer 140 or both.

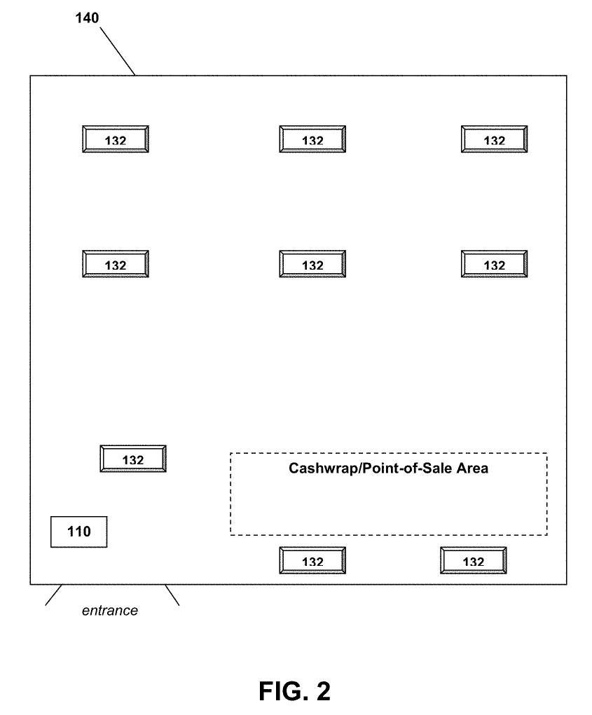

Referring to FIGS. 1 and 2, system 100 comprises display module 130 communicatively coupled with advertising module 120. The communicative coupling between display module 130 and advertising module 120 can be the same as or similar to the coupling between customer-member identification module 110 and advertising module 120 discussed herein above. Display module 130 comprises at least one display 132, such as a visual or interactive (e.g., touch sensitive) display or screen arranged at or in retailer 140. Display 132 can comprise a light emitting diode (LED) display, liquid crystal display (LCD), computer screen, tablet screen, projection or projected display, holographic image or display, combinations of these displays, or other types of viewable screens or display arrangements. Display 132 can additionally or instead comprise an audio component, such as a speaker or other sound-transmitting device. In one example, display module 130 comprises a plurality of displays 132 each arranged at a different location in retailer 140. The locations can be fixed or mobile and can be on walls, shelving or fixtures; suspended from the ceiling; mounted on shopping carts; arranged at check-out, deli, cashwrap, waiting or customer service areas; mounted on gas pumps or in restroom facilities; or in any other location in or at retailer 140. Other embodiments can comprise more or fewer displays 132 than are depicted only as one example in FIG. 2.

In still other embodiments, display(s) 132 of display module 130 can be located in other retailers 140. For example, a retailer may have several locations 140 in one city, state, region or other geographic, distribution or sales area, and display(s) 132 in two or more locations can be linked or coordinated within or among these areas.

In another example, display module 130 can be communicatively coupled with a mobile application (“app”) associated with retailer 140 and downloadable by customer-members to their mobile phones or other devices. Display module 130 then can include the displays 132 of these devices, in that content can be pushed to the mobile devices by retailer 140 (e.g., by advertising module 120) for viewing by the customer-members associated with those devices. In one embodiment, advertising module 120 may only do this, or the app may only permit some content to be displayed on the mobile device, when that mobile device is in or near retailer 140. This can be determined via customer-member identification module 110, which as previously discussed can interface with customer-member mobile devices in embodiments or may otherwise identify that a particular customer-member is at or in retailer 140. In another embodiment, customer-members must specifically opt in for receiving certain content (e.g., advertisements) on their mobile devices, though this can be a requirement of or inherent to using the app of retailer 140 in some embodiments.

Display module 130 is configured to display, via displays 132, the above-discussed advertisement developed based on customer-member content and retailer 140 content. In embodiments, display module 130 is caused to display the advertisement by at least one of advertising module 120 or customer-member identification module 110.

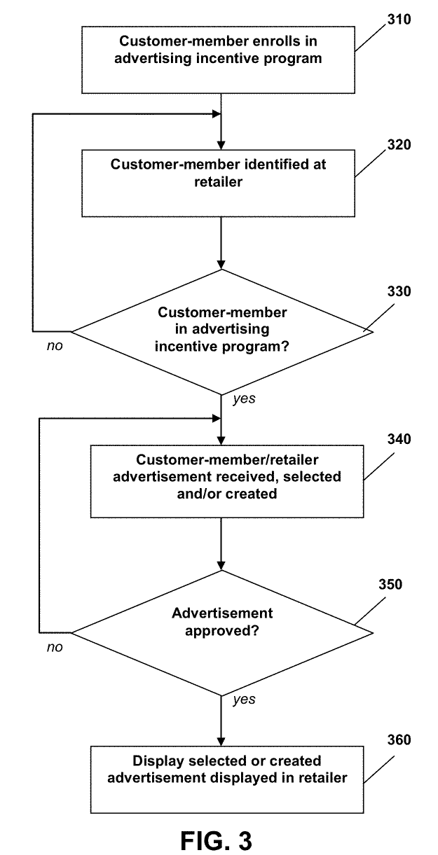

For example, and referring also to FIG. 3, in one embodiment a customer-member enrolls in an advertising incentive program with retailer 140, at 310. At 320, the customer-member visits retailer 140 and is identified via interaction with customer-member identification module 110. Customer-member identification information is sent from customer-member identification module 110 to advertising module 120. Upon receipt of the customer-member identification information, advertising module 120 determines whether the customer-member is enrolled in the in-store advertising incentive program, at 330. If the customer-member is enrolled and any other program requirements are met (e.g., the customer-member has met any minimum purchase requirements, the customer-member has met any minimum number of visits to retailer 140 requirements, the customer-member has provided a suitable advertisement or advertisement information or has met other retailer or program requirements), advertising module 120 selects or creates an advertisement, at 340. If the advertisement is approved at 350, advertising module 120 provides the advertisement to display module 130, and the advertisement is displayed via display(s) 132 at 360. In another embodiment in which the advertisement is a print-type (i.e., hardcopy) advertisement, advertising module 120 can, additionally or alternatively, cause a print-type advertisement to be displayed or made available for distribution (e.g., on display(s) 132; by being printed on a receipt; by being printed on a retailer guide to specials, a weekly ad included with newspapers, or on another circular or document; by being included on a billboard, signage or other display area in or at retailer 140 or elsewhere; or in some other way or combination of these ways). If the advertisement is not approved at 350, the customer-member can be notified and prompted to provide additional or alternate advertisement information, select a new advertisement, or take other action. In other embodiments, additional tasks can be added, or depicted tasks can be omitted, from that which is depicted and discussed with respect to FIG. 3.

The advertisement can be displayed while the customer-member is in or at retailer 140 or at other times. For example, a customer-member may earn display frequency, times, and/or prioritization, including during preferred or peak traffic times in retailer 140, based on their number of visits to retailer 140 or an amount spent at retailer 140. In another embodiment, customer-member visits or purchases at retailer 140 can earn them incentive program “points” that can be used to select advertisement displays times and frequency or earn recurring advertisement displays (e.g., daily, weekly, monthly). In embodiments in which display(s) 132 are located in a plurality of retailers 140, the advertisement can be displayed on one, some or all of the display(s), or the customer-member may bid for: certain times in certain retailer 140 locations; a larger number of display(s) 132 in a particular location or more than one location; retailer 140 locations near customer-member business locations; or other display schemes. In other words, the advertisement need be displayed, only or at all, in retailer location(s) 140 visited by the customer member. Still other arrangements and schemes can be used in other embodiments. In general, an advantage of system 100 is that it can encourage customer-members to visit retailer 140 in order to increase their advertising opportunities, thereby increasing customer-member engagement with retailer 140.

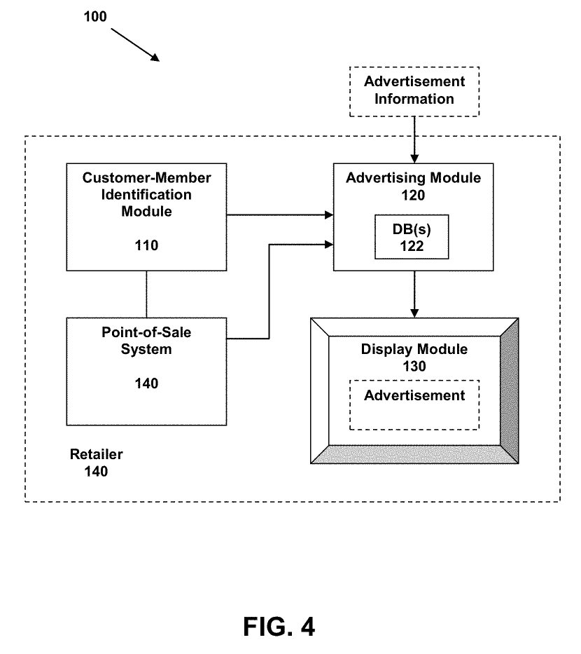

As discussed previously, some embodiments of the in-store advertizing systems discussed herein can use purchase or other information related to customer-members. Referring to FIG. 4, in embodiments system 100 can further comprise point-of-sale (POS) system 140. POS system 140 can comprise or be communicatively coupled with the cash register computer system in retailer 140 (and/or an online payment system for retailers having web-based stores) in order to provide information about purchases made by customer-members in or from retailer 140. In membership-based retail or other business, customer-members typically must provide a membership card or other identification information at the time of making purchases, similar to as discussed above to identify the customer-members by or at customer-member identification module 110. This can enable system 100 to link information about customer-member visits to or presence at retailer 140 with purchases made at or from retailer 140, including purchases made during particular visits. Additionally, customer-member check-out via POS system 140 can provide advertising module 120 with that information so that advertising module 120 can determine customer-member visit duration and other information. In still other embodiments, customer-member identification module 110 can comprise an additional unit at POS system 140 or proximate an exit of retailer 140 to determine when a customer-member is leaving retailer 140.

Database(s) 122 can store data and information from POS system 140 and use this data to determine characteristics associated with developing and/or displaying advertisements via display module 130. Advertising module 120 also can use this information, from any or all customer-members, including those who are not business owners or participating in the advertising incentive program, to determine effectiveness of the advertisements and provide incentives to customer-members or employees. For example, if advertising module 120 determines that retailer 140 sees an increase in strawberry sales when the customer-member's advertisement featuring strawberries and pie is displayed, advertising module 120 may reward that customer-member with additional advertisement display time or use that information to create other successful in-store advertisements. Additional analytics can be performed, such as those related to determining how customer-members shop in order to make in-store improvements or enhancements, offer different or additional products and services, and market more effectively to customer-members, among others. In one embodiment, these additional analytics can include reviewing time, day or seasonal information related to the advertisement and purchases; reviewing the type of information chosen for advertisement by customer-members; reviewing types of products purchased to identify complementary products; identifying areas of retailer 140 that are or are not visited by some customer-members; and others.

In yet another embodiment, POS system 140 is configured to receive purchase data of the customer-member, identify from the purchase data a product that relates to an advertisement of the customer member (e.g., one stored in database(s) 122), and cause advertising module 120 and display module 130 to display information related to the identified product with the advertisement on display(s) 132.

In embodiments, system 100 and/or its components or systems can include computing devices, microprocessors, modules and other computer or computing devices, which can be any programmable device that accepts digital data as input, is configured to process the input according to instructions or algorithms, and provides results as outputs. In an embodiment, computing and other such devices discussed herein can be, comprise, contain or be coupled to a central processing unit (CPU) configured to carry out the instructions of a computer program. Computing and other such devices discussed herein are therefore configured to perform basic arithmetical, logical, and input/output operations.

Computing and other devices discussed herein can include memory. Memory can comprise volatile or non-volatile memory as required by the coupled computing device or processor to not only provide space to execute the instructions or algorithms, but also to provide the space to store the instructions themselves. In embodiments, volatile memory can include random access memory (RAM), dynamic random access memory (DRAM), or static random access memory (SRAM), for example. In embodiments, non-volatile memory can include read-only memory, flash memory, ferroelectric RAM, hard disk, floppy disk, magnetic tape, or optical disc storage, for example. The foregoing lists in no way limit the type of memory that can be used, as these embodiments are given only by way of example and are not intended to limit the scope of the invention.

In embodiments, the system or components thereof can comprise or include various modules or engines, each of which is constructed, programmed, configured, or otherwise adapted, to autonomously carry out a function or set of functions. The term “engine” as used herein is defined as a real-world device, component, or arrangement of components implemented using hardware, such as by an application specific integrated circuit (ASIC) or field-programmable gate array (FPGA), for example, or as a combination of hardware and software, such as by a microprocessor system and a set of program instructions that adapt the engine to implement the particular functionality, which (while being executed) transform the microprocessor system into a special-purpose device. An engine can also be implemented as a combination of the two, with certain functions facilitated by hardware alone, and other functions facilitated by a combination of hardware and software. In certain implementations, at least a portion, and in some cases, all, of an engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each engine can be realized in a variety of physically realizable configurations, and should generally not be limited to any particular implementation exemplified herein, unless such limitations are expressly called out. In addition, an engine can itself be composed of more than one sub-engines, each of which can be regarded as an engine in its own right. Moreover, in the embodiments described herein, each of the various engines corresponds to a defined autonomous functionality; however, it should be understood that in other contemplated embodiments, each functionality can be distributed to more than one engine. Likewise, in other contemplated embodiments, multiple defined functionalities may be implemented by a single engine that performs those multiple functions, possibly alongside other functions, or distributed differently among a set of engines than specifically illustrated in the examples herein.

Various embodiments of systems, devices, and methods have been described herein. These embodiments are given only by way of example and are not intended to limit the scope of the invention. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the invention.

Persons of ordinary skill in the relevant arts will recognize that the invention may comprise fewer features than illustrated in any individual embodiment described above. The embodiments described herein are not meant to be an exhaustive presentation of the ways in which the various features of the invention may be combined. Accordingly, the embodiments are not mutually exclusive combinations of features; rather, the invention may comprise a combination of different individual features selected from different individual embodiments, as understood by persons of ordinary skill in the art.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims for the present invention, it is expressly intended that the provisions of Section 112, sixth paragraph of 35 U.S.C. are not to be invoked unless the specific terms “means for” or “step for” are recited in a claim.

1. A system for providing an advertizing incentive, by a retailer having a retail location and offering a member relationship to customers, to a customer-member of the retailer, comprising:
an electronic customer-member identification module configured to be arranged in the retail location to identify a presence in the retail location of a customer-member of the retailer;
a display module; and
an advertising module communicatively coupled with the electronic customer-member identification module and the display module and configured to receive an electronic advertisement related to the customer-member and to cause the display module to display the electronic advertisement according to at least one characteristic related to the identified presence of the customer-member in the retail location.

2. The system of claim 1, wherein the electronic customer-member identification module is communicatively coupled with a point-of-sale (POS) system of the retailer.

3. The system of claim 2, wherein the advertising module is communicatively coupled with the POS system and configured to receive purchase data of the customer-member, identify from the purchase data a product that relates to the electronic advertisement, and display information related to the identified product with the electronic advertisement in the business location.

4. The system of claim 3, wherein the information related to the identified product includes at least one of a product name, a product brand, a product price, a product location in the business location, or a product offer.

5. The system of claim 2, wherein the POS system comprises at least a portion of the electronic customer-member identification module.

6. The system of claim 6, wherein the electronic customer-member identification module comprises at least one of a magnetic stripe reader, a bar code reader, a contactless electronic payment terminal, a chip-and-pin reader, a biometric identification system, a scanner, a mouse, a camera, a voice recognition system, a radio frequency identification (RFID) system, a BLUETOOTH system, a WIFI system, a near-field communication (NFC) antenna, or a keyboard.

7. The system of claim 1, wherein the electronic customer-member identification module is configured to be arranged proximate an entrance of the retail location to detect an entrance into the retail location of the customer-member.

8. The system of claim 7, wherein the electronic customer-member identification module is configured to automatically detect an entrance into the retail location of the customer-member.

9. The system of claim 7, wherein the electronic customer-member identification module is configured to detect an entrance into the retail location of the customer-member based on an interaction with the customer-member.

10. The system of claim 1, wherein the at least one characteristic comprises a number of times the presence of the customer-member in the retail location is identified, and wherein the advertising module is configured to increase at least one of a length of time the advertisement is displayed, a frequency of display of the advertisement, or a value of the time at which the advertisement is displayed as the number of times increases.

11. The system of claim 1, wherein the at least one characteristic comprises an amount purchased by the customer-member in the retail location, and wherein the advertising module is configured to increase at least one of a length of time the advertisement is displayed, a frequency of display of the advertisement, or a value of the time at which the advertisement is displayed as the amount purchased increases.

12. The system of claim 1, wherein the display module comprises at least one display on which the advertisement is displayed.

13. The system of claim 12, wherein at least one of the displays is located at the retail location.

14. The system of claim 12, wherein at least one of the displays is located at a different retail location.

15. A method of providing an advertizing incentive, by a retailer having a retail location and offering a member relationship with customers, to a customer-member of the retailer, comprising:
receiving an electronic advertisement from to the customer-member;
identifying, by an electronic customer-member identification module configured to be arranged in the retail location, a presence in the retail location of the customer-member; and
causing to be displayed on a display module, by an advertising module communicatively coupled with the electronic customer-member identification module, the electronic advertisement in the retail location according to at least one characteristic related to the identifying of the customer-member in the retail location.

16. The method of claim 15, further comprising:
receiving, by the electronic customer-member identification module from a point-of-sale (POS) system of the retail location, purchase data of the customer-member;
identifying from the purchase data a product that relates to the electronic advertisement; and
displaying information related to the identified product with the electronic advertisement in the retail location.

17. The method of claim 16, wherein the information related to the identified product includes at least one of a product name, a product brand, a product price, a product location in the business location, or a product offer.

18. The method of claim 15, further comprising arranging the electronic customer-member identification module proximate an entrance to the retail location.

19. The method of claim 18, wherein the detecting further comprises automatically identifying an entrance into the retail location of the customer-member.

20. The method of claim 18, wherein the identifying further comprises receiving information by the electronic customer-member identification module based on an interaction between the customer-member and the electronic customer-member identification module.

21. The method of claim 15, wherein the at least one characteristic comprises a number of times the presence of the customer-member in the retail location is identified, and wherein the causing to be displayed further comprises increasing at least one of a length of time the advertisement is displayed, a frequency of display of the advertisement, or a value of the time at which the advertisement is displayed as the number of times increases.

22. The method of claim 15, wherein the at least one characteristic comprises an amount purchased by the customer-member in the retail location, and wherein the displaying further comprises increasing at least one of a length of time the advertisement is displayed, a frequency of display of the advertisement, or a value of the time at which the advertisement is displayed as the amount purchased increases.
